(19) United States
(12) Patent Application Publication
(10) Pub. No.: US 2009/0091504 A1
(43) Pub. Date: Apr. 9, 2009

(54) LOW-PROFILE FEED-OFFSET WIDEBAND ANTENNA

(75) Inventor: Stanislav Licul, Damascus, MD (US)

Correspondence Address: DLA PIPER LLP (US);ATTN: PATENT GROUP, 500 8th Street, NW, WASHINGTON, DC, 20004-2131, US

(73) Assignee: ZYLAYA CORPORATION, Gaithersburg, MD (US)

(21) Appl. No.: 11/867,405

(22) Filed: Oct. 4, 2007

(51) Int. Cl. H01Q 1/38; H01Q 1/12

(52) U.S. Cl. 343/718; 343/700 MS

(57) ABSTRACT

An antenna includes a body having first and second lateral arms. The body also includes a central offset section connecting to the first and the second lateral arms, and first and second antenna ports connected to the central offset section. The antenna has a bandwidth greater than a maximum frequency shift of a resonance frequency of the antenna caused by a loading of the antenna by a human hand.

### BACKGROUND

### Field of the Invention

The present invention relates generally to antennas, and relates specifically to a low-profile feed-offset wideband antenna, a wireless communication device using the same and a method of communicating using the wireless device.

### BRIEF SUMMARY

An aspect of the present invention is to provide an antenna, a wireless communication device including the antenna and a method of using the wireless device. The antenna includes first and second lateral arms. The antenna also includes a central offset section connected to the first and the second lateral arms, and first and second antenna ports connected to the central offset section. A bandwidth of the antenna is greater than a maximum frequency shift of a resonance frequency of the antenna caused by a loading of the antenna by a human hand.

### BRIEF DESCRIPTION OF THE DRAWINGS

FIG. 1A illustrates a three dimensional perspective view of a structure of a low-profile feed-offset wideband (LPW) antenna, according to an embodiment of the present invention;

FIG. 1B is a top view of the LPW antenna shown in FIG. 1A;

FIG. 1C is a front view of the LPW antenna shown in FIG. 1A;

FIG. 1D is a side view of the LPW antenna shown in FIG. 1A;

FIG. 1E is a sectional view of the LPW antenna shown in FIG. 1A, at section A-A denoted in FIG. 1A and in FIG. 1B;

FIGS. 2A and 2B show a positioning of the LPW antenna inside a communication device held by a user under different hand grip conditions;

FIGS. 3A and 3B depict a graph of a narrowband antenna return loss under the loading condition shown in FIG. 2A;

FIGS. 4A and 4B depict a graph of a narrowband antenna return loss under the loading condition shown in FIG. 2B;

FIGS. 5A and 5B depict a graph of the LPW antenna return loss under the loading condition shown in FIG. 2A;

FIGS. 6A and 6B depict a graph of the LPW antenna return loss under the loading condition shown in FIG. 2B;

FIGS. 7A and 7B show contour plots of patterns of the narrowband antenna under the load conditions depicted in FIGS. 2A and 2B, respectively; and

FIGS. 8A and 8B show contour plots of patterns of the LPW antenna under the load conditions depicted in FIGS. 2A and 2B, respectively.

### DETAILED DESCRIPTION

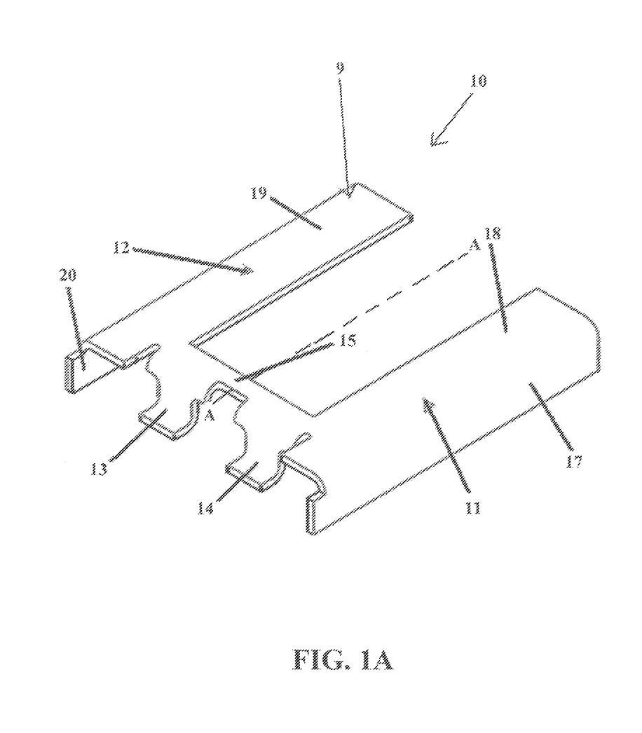

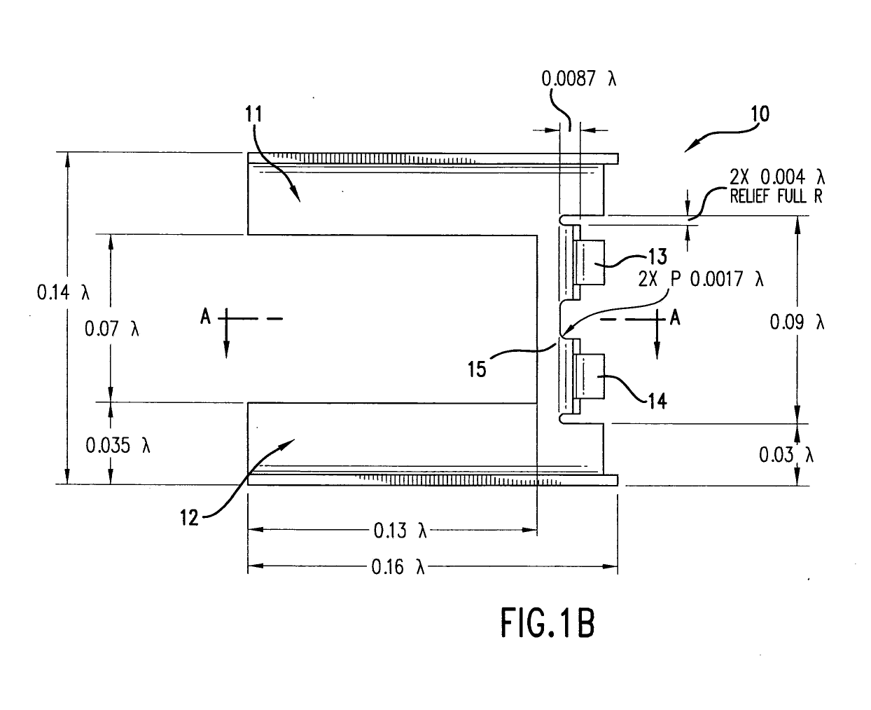

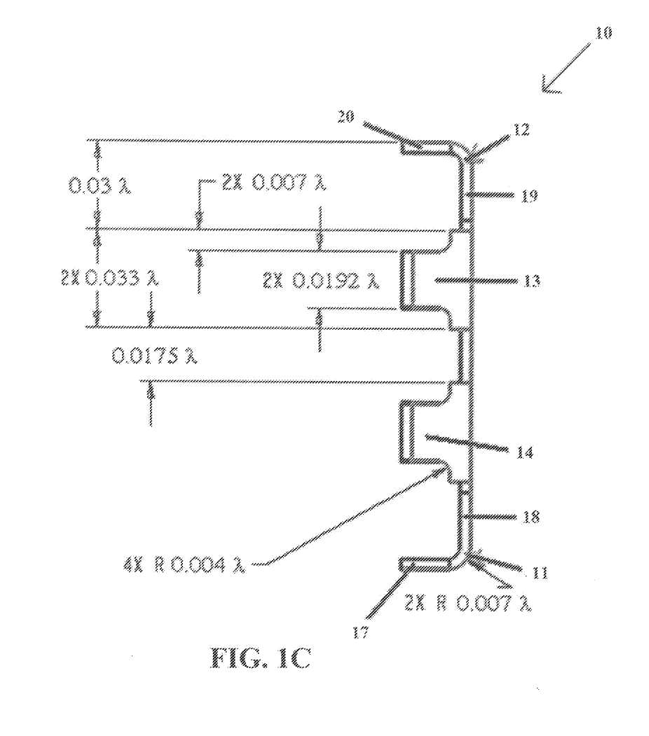

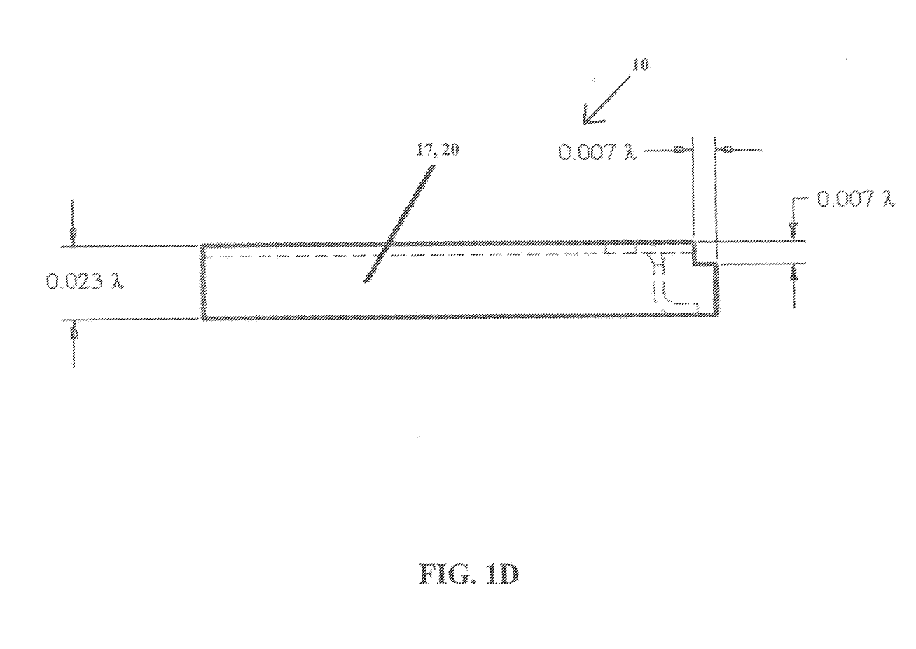

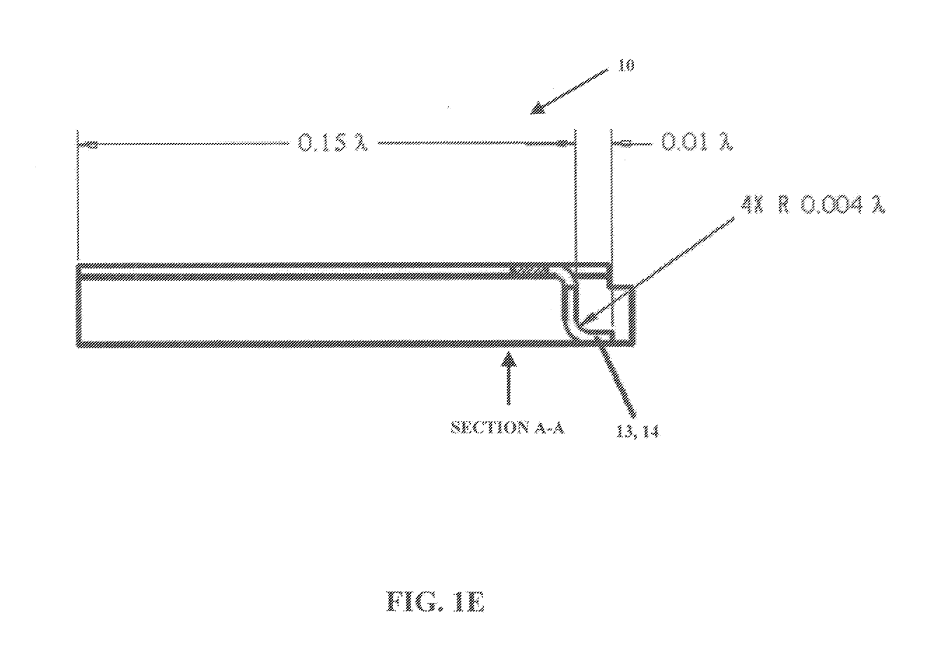

FIG. 1A illustrates a three dimensional perspective view of a structure of a low-profile feed-offset wideband (LPW) antenna 10, according to an embodiment of the present invention. The LPW antenna 10 includes a body 9. Generally, the body 9 has U-like shape. The body 9 has lateral arms 11 and 12, first antenna port 13, second antenna port 14, and bridge or central offset section 15 that connects to lateral arms 11 and 12. In one embodiment, the first antenna port 13 and the second antenna port 14 are provided in the central offset section 15. As shown in FIG. 1A, the first and second antenna ports 13 and 14 can be an integral part of the central offset section 15. In which case, the antenna ports 13 and 14 can be formed from cut-out portions in the central offset section 15. The antenna ports 13 and 14 are bent in L-like conformation so that the antenna ports 13 and 14 point opposite to elongated portions of the lateral arms 11 and 12. Although the antenna ports 13 and 14 are shown formed as integral parts of the central offset section 15, it must be appreciated that the antenna ports 13 and 14 can also be attached to the central offset section 15 using fasteners. Furthermore, although the ports 13 and 14 are shown having a L-like shape, any other suitable shape can also be contemplated. For example, the antenna ports 13 and 14 can be formed (e.g., cut and/or bent) so that the ports 13 and 14 are oriented to point towards a same direction as the elongated portions of the lateral arms 11 and 12.

The lateral arm 11 has top segment 18 and side segment 17. The lateral arm 12 has top segment 19 and side segment 20. The segments 17 and 18 of lateral arm 11 form a L-shaped arm 11. Similarly, the segments 19 and 20 of lateral arm 12 also form a L-shaped arm 12. The lateral arms 11 and 12 are formed from a continuous electrically conductive material. Specifically, the top segment 18 and side segment 17 of the lateral arm 11 and the top segment 19 and side segment 20 of lateral arm 12 are formed from a continuous conductive material, in a sense that the conductive material is free from discontinuities or gaps such as holes, slots or the like. In the embodiment depicted in FIG. 1A, an angle between the segments 17 and 18 is approximately 90° and an angle between the segments 19 and 20 is approximately 90°. However, the angle between the segments 17 and 18 and the angle between the segments 19 and 20 can be any desired angle. For example, the angle can be selected to fit a certain conformation or optimized so that the antenna 10 communicates, i.e., receives and/or transmits, in a certain range of frequencies.

In one embodiment, the first antenna port 13 is used as an antenna feed port and the second antenna port 14 is used as an antenna ground port. However, the antenna ports 13 and 14 are interchangeable. In another embodiment, the first antenna port 13 is used as an antenna ground port and the second antenna port 14 is used as an antenna feed port.

The body 9 of antenna 10 can be made from any suitable conductive material. For example, the body 9 can be made from a sheet of metal such as copper, iron, aluminum, or any suitable metal alloy. The sheet of metal can be formed (e.g., cut, bent, shaped, stamped, etc.) to conform to the geometry of the body 9 of the antenna 10. The sheet of metal can be selected to have any desired thickness. In one embodiment, the thickness of the metal sheet is about 1 mm. However, the thickness of the sheet of metal can also be as low as 50 μm depending on the application sought.

The dimensions of body 9 of the antenna 10 can be selected as desired according to a desired application. For example, the dimensions of the various parts, including the dimensions of the segments 17, 18, 19 and 20 in lateral arms 11 and 12 and central offset section 15 that connects to lateral arms 11 and 12, can be selected according to a wavelength or frequency of the signal that antenna is intended to receive or transmit.

FIGS. 1B-1E depict various views of the antenna shown in FIG. 1A showing dimensions of the various features of the antenna 10, according to an embodiment of the present invention. FIG. 1B is a top view of the LPW antenna shown in FIG. 1A. FIG. 1C is a front view of the LPW antenna shown in FIG. 1A. FIG. 1D is a side view of the LPW antenna shown in FIG. 1A. FIG. 1E is a sectional view of the LPW antenna shown in FIG. 1A, at section A-A denoted in FIG. 1A and in FIG. 1B. The dimensions of the various features of the antenna 10 are expressed as a function of the wavelength (λ). Hence, depending on the wavelength or frequency band in which the antenna 10 is intended to operate, the dimensions of the antenna can be tailored for that wavelength or frequency band. For example, as shown in FIG. 1B, a length of the elongated lateral arms 11 and 12 is about 0.12λ, and the length of the central offset section (bridge) 15 is about 0.14λ. A distance between the lateral arms 11 and 12 is about 0.07λ. A width of the top segments 18 and 19 is about 0.035λ. Also, as shown in FIG. 1C, a width of the antenna port 13 or antenna port 14 is about (2×0.0192λ). A spacing between the antenna ports 12 and 13 is about 0.0175λ. As shown in FIG. 1C, a radius of curvature of the antenna port 13 or antenna port 14 at a junction with the central offset section 15 is about (4×0.004λ). As shown in FIGS. 1A and 1B, the antenna ports 13 and 14 are offset relative to the edge of side segments 17 and 20 of lateral arms 11 and 12. A radius of curvature between the side segment 17 and the top segment 18 and/or a radius of curvature between the top segment 19 and side segment 20 is about (2×0.007λ). As shown in FIGS. 1D and 1E, the width of side segment 17, 20 is about 0.023λ. A length of the top segments 18 and 19 can be equal or less than the length of the respective side segments 17 and 20. In one embodiment, the length of the top segments 18, 19 is less than the length of the respective side segments 17, 20 by about 0.007λ, as shown in FIG. 1D. Other dimensions of the various features of the antenna 10 are indicated in FIGS. 1B, 1C, 1D and 1E. Although the various features are shown having specific dimensions in the FIGS. 1B-1E, these dimensions are merely one possible set of dimensions that the features of the antenna may take. Hence, it must be appreciated that other dimensions can be selected for the various features to achieve a certain antenna design tailored for a desired application.

For example, in one embodiment, a physical length of the antenna can be selected to be equal to a fraction of the wavelength of the signal, for example 0.2λ, to achieve antenna efficiency of about 30% to about 40% (for approximately −6 dB return loss). For example, a dimension of the first lateral and second lateral arms 11 and 12 and/or a dimension of the central offset portion 15 can be equal to a fraction of a wavelength (e.g., 0.2λ) of the signal transmitted and/or received by the antenna 10.

The antenna 10 can be mounted on a substrate material, i.e., the body 9 of the antenna 10 can be disposed on the substrate material. For example, the antenna 10 can be mounted on a printed circuit board (PCB) (not shown). The PCB can be made from a fiberglass type material such as FR-4 type. The PCB can be provided with a copper ground. Ground clearance underneath the lateral arms 11 and 12 may be established for low profile antenna implementations. To achieve an antenna efficiency between about 30% and about 40% for a return loss of about −6 dB, the dimensions of the PCB substrate supporting the antenna is set at approximately 0.2λ. However, ground clearance can be minimized or even substantially eliminated when using a substrate comprising a dielectric material (e.g., ceramic) to support the antenna 10.

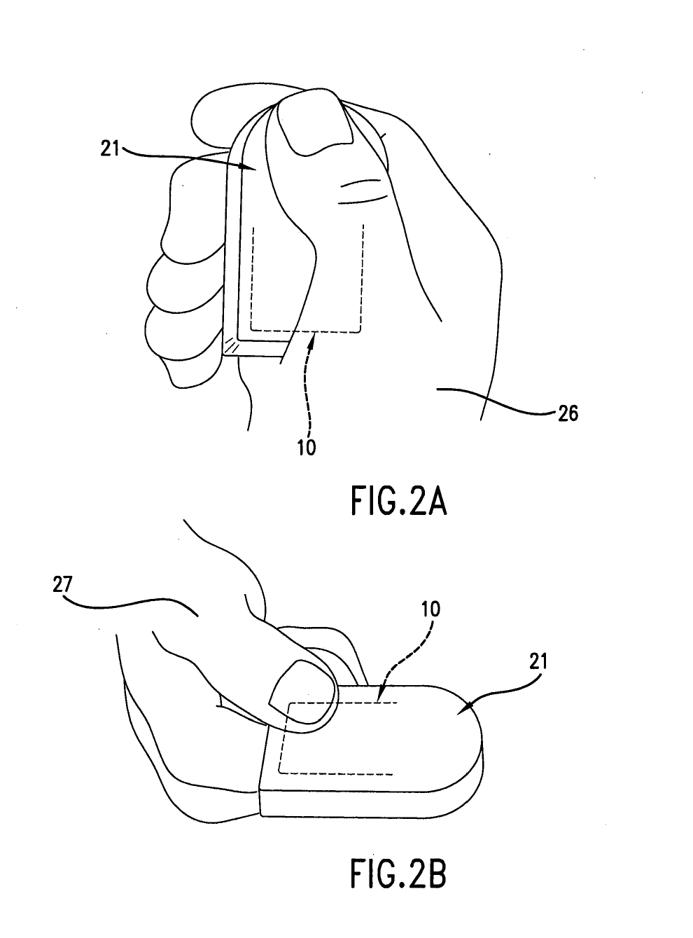

FIGS. 2A and 2B show a positioning of the antenna 10 inside a communications device 21 held by a user under different hand grip conditions. FIG. 2A illustrates a typical hand grip 26 in which a hand of user encloses approximately 75% of a total volume of device 21 in which the antenna 10, schematically represented by a U-shaped line in FIG. 2A, is imbedded. FIG. 2B illustrates another typical hand grip 27 in which a hand of a user encloses approximately 10% of a total volume of device 21 in which the antenna 10, schematically represented by a U-shaped line in FIG. 2B, is enclosed.

Under different hand grip conditions, the antenna 10 is subject to different loading conditions which is reflected on the antenna return loss, efficiency, and overall performance of the device 21. In particular, if the hand of a user encloses 10% to 75% of the volume of the device 21, the frequency of the signal transmitted or received by the device may be shifted. The frequency shift can be anywhere between about 5 MHz and about 155 MHz. In most cases, the narrowband antenna bandwidth is only around 4% of the frequency band of communication. Thus, a particular loading condition may cause significant antenna detuning. Detuning of an antenna contributes to the degradation of the antenna efficiency due to impedance mismatch.

By using the LPW antenna 10, for a wide variety of loading conditions, detuning can be minimized and the antenna can exhibit greater than −6 dB in return loss over a frequency band of interest, hence increasing the antenna efficiency without the need of matching networks or switching networks to compensate for frequency shift.

In the following paragraphs a comparison between characteristics of the low-profile feed offset wideband (LPW) antenna 10 and a conventional narrowband antenna in a same setting disposed within the communication device 21 is discussed. In such a setting, both the LPW antenna 10 and the conventional narrowband antenna are exposed to the same hand loading conditions as shown in FIGS. 2A and 2B. In one embodiment, the communication device 21 has a total volume of 23868 mm³ (68 mm×39 mm×9 mm). In general, the wireless device can have a maximum diagonal dimension less than about 5 inches (about 12 cm).

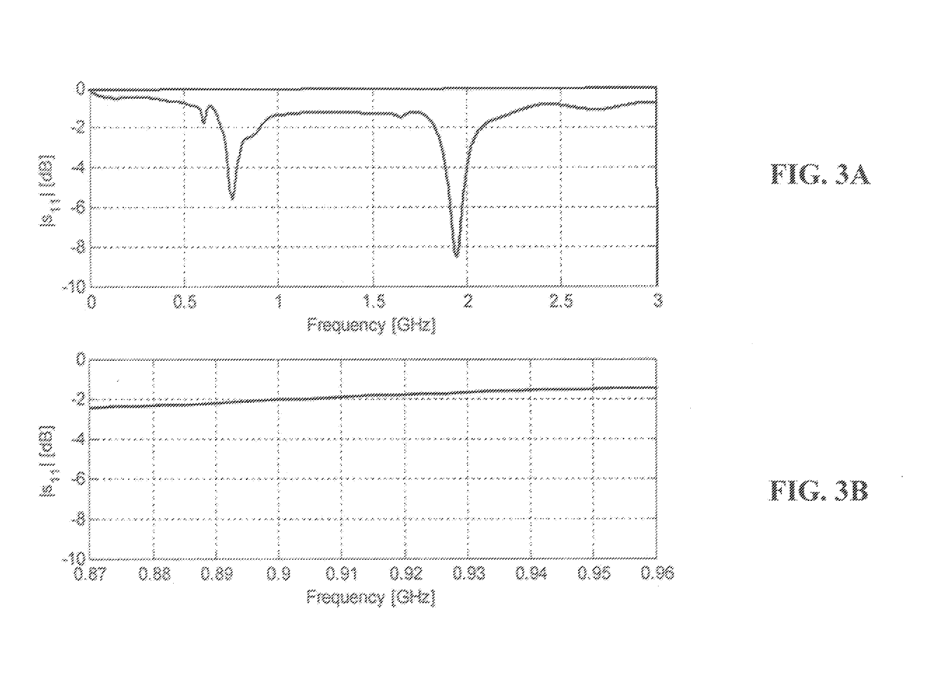

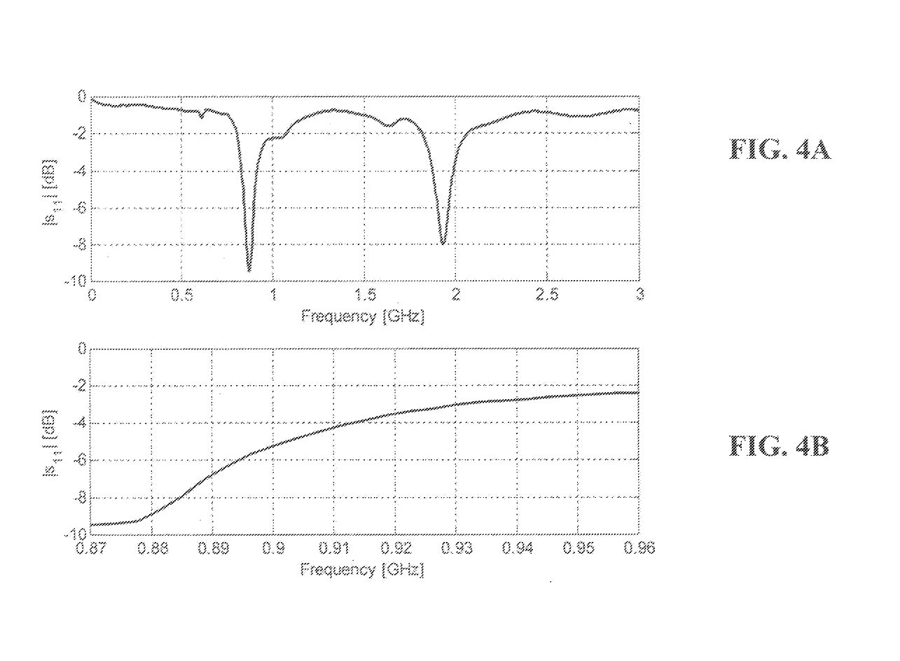

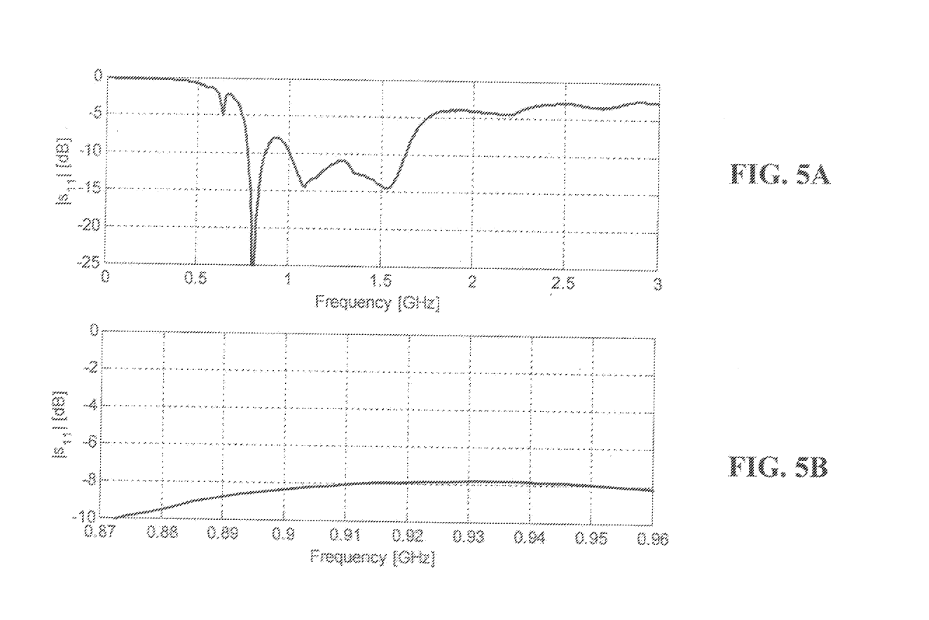

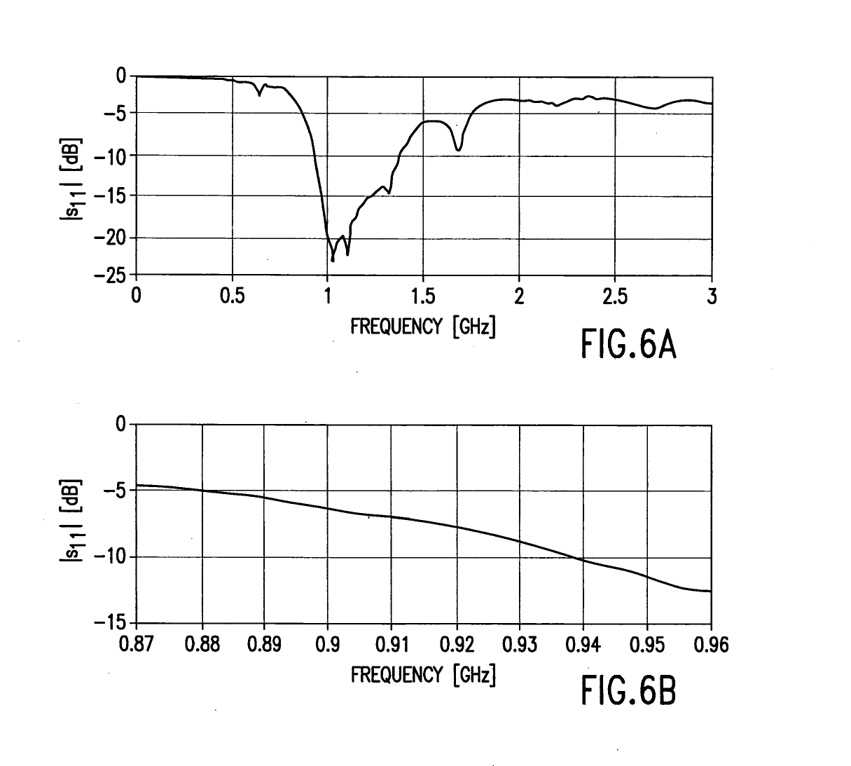

FIGS. 3A and 3B depict a graph of a narrowband antenna return loss under the loading condition shown in FIG. 2A. FIGS. 4A and 4B depict a graph of a narrowband antenna return loss under the loading condition shown in FIG. 2B. FIGS. 5A and 5B depict a graph of LPW antenna return loss under the loading condition shown in FIG. 2A. FIGS. 6A and 6B depict a graph of LPW antenna return loss under the loading condition shown in FIG. 2B. The ordinate axis represents the S11 parameter in dB and the abscissa axis represents the frequency of a transmitted/received signal in GHz. The S11 parameter corresponds to the input port voltage reflection coefficient. In other words, the S11 parameter is the reflected voltage magnitude divided by the incident voltage magnitude. FIGS. 3A, 4A, 5A and 6A show the profile of the return loss in the frequency range 0 GHz to 3 GHz. FIGS. 3B, 4B, 5B and 6B show the profile of the return loss in the frequency range 870 MHz to 960 MHz which includes the ISM frequency band (between about 902 MHz and about 928 MHz).

The conventional narrowband antenna is tuned around 905 MHz. The bandwidth of the narrowband antenna, at a return loss of about −6 dB in free space, is about 40 MHz. The narrowband antenna has 4.4% bandwidth relative to the frequency band of communication. In order to achieve matching, a single capacitive matching element is used. When loading the narrowband antenna by the hand grip 26, as shown in FIG. 2A, the antenna resonance frequency is shifted to about 750 MHz as shown in FIG. 3A. The total frequency shift is significant, about 155 MHz. If the device 21 is intended to operate in and cover the ISM frequency band between about 902 MHz and about 928 MHz, it is clear from FIGS. 3A and 3B that antenna loading significantly detunes the narrowband antenna. Indeed, the return loss of the narrowband antenna around 750 MHz is around −6 dB while the return loss of the narrow band antenna around the ISM frequency band, in which the device 21 is intended to operate, is about −2 dB, as shown in FIG. 3B. Hence, the detuning creates a significant loss in efficiency. The antenna efficiency drops from about 27% in the free space to only about 2% under the loading conditions shown in FIG. 2A. In general, the human body presents a significant loss to electromagnetic propagation at ISM band frequencies.

When the narrowband antenna is loaded by the hand grip 27, as depicted in FIG. 2B, the antenna resonance frequency is shifted by 35 MHz, as shown in FIG. 4A. The shift, in this case, is not as pronounced as under the hand grip 26 depicted in FIG. 2A. However, the efficiency drops from about 27% in the free space to about 11% under the loading condition depicted in FIG. 2B.

In order for a conventional narrowband antenna to adequately cover the frequency band of interest and provide an adequate return loss around the frequency band of interest (the operating frequency band of the device 21) under loading conditions depicted in FIGS. 2A and 2B, the bandwidth of the narrowband antenna has to be increased. However, the bandwidth of such antenna is very limited (around 40 MHz). Therefore, in order to achieve desired efficiency and an adequate return loss in the narrowband antenna, the conventional narrowband antenna must be provided with tuning capability to compensate for frequency shift by using matching networks or switching networks.

On the other hand, the bandwidth of the LPW antenna 10, at a return loss of about −6 dB in free space, is greater than that of the conventional narrowband antenna. The bandwidth of the LPW antenna 10, at a return loss of about −6 dB in free space, can be about 750 MHz which is greater than the bandwidth of 40 MHz of the narrowband antenna. As shown in FIGS. 5A, 5B, 6A and 6B, the wideband nature of LPW antenna provides a return loss of the antenna of less than about −6 dB for a wide variety of loading conditions, such as loading conditions depicted in FIGS. 2A and 2B. The LPW antenna 10 can be tuned, for example in free space, to the ISM band by selecting appropriate dimensions of the antenna 10. For example, a diagonal dimension of the antenna 10, can be selected so that the antenna 10 be tuned to the ISM band which starts at 902 MHz. When loading the LPW antenna by, for example the hand grip 26 as shown in FIG. 2A, even if the antenna resonance frequency is shifted by the hand loading condition, the relatively wide bandwidth (about 750 MHz which is about 58% of the frequency band of communication, i.e. greater than 55% of the frequency band of communication) of the LPW antenna allows to maintain coverage of the frequency band of interest, for example the ISM band (between about 902 MHz and about 928 MHz), as shown in FIGS. 5A and 5B. For example, as shown in FIG. 5B, the return loss in the ISM band is about −8 dB. Similarly, when loading the LPW antenna by the hand grip 27 as shown in FIG. 2B, even if the antenna resonance frequency is shifted by the hand loading condition, the relatively wide bandwidth (about 750 MHz which is about 58% of the frequency band of communication) of the LPW antenna allows to maintain coverage of the frequency band of interest, for example the ISM band (between about 902 MHz and about 928 MHz), as shown in FIGS. 6A and 6B. For example, as shown in FIG. 6B, the return loss in the ISM band is in the range of −6 dB to about −10 dB. In other words, the wide bandwidth of the antenna (e.g., about 750 MHz) provides adequate coverage of a frequency band of interest (e.g., around 900 MHz) even when the resonance frequency of the antenna is shifted by a loading condition, such as the loading condition depicted in FIG. 2A or the loading condition depicted in FIG. 2B. This can also be expressed as the bandwidth of the antenna being greater than a maximum frequency shift of the resonance frequency arising from a hand loading condition.

The percentage bandwidth (pbw) or the fractional bandwidth of antenna 10 can be calculated by dividing the bandwidth of the antenna by half of the sum of a high end of the frequency band of communication and low end of the frequency band of communication. The half of the sum of the high end of the frequency band of communication and low end of the frequency band of communication corresponds to the mid point of the frequency band of communication. For example, if the frequency band of interest is the ISM frequency band, the percentage bandwidth (pbw) of antenna 10 is equal to the bandwidth of the antenna (e.g., about 750 MHz measured at a return loss of −6 dB) divided by half of the sum of the high end of the frequency band of communication which is about (902 MHz+750 MHz=1652 MHz) and the low end of the frequency band of communication which is about 902 MHz. This provides a percentage bandwidth of about 58%.

The efficiency of the LPW antenna is about 6% under the hand loading condition of FIG. 2A and about 22% under the hand loading condition of FIG. 2B. The LPW antenna presents 4 dB improvement over the narrowband antenna solution while the LPW antenna occupies the same volume as the narrowband antenna. In other words, the efficiency of the LPW antenna exceeds the efficiency of a conventional narrowband antenna by 3 dB or more.

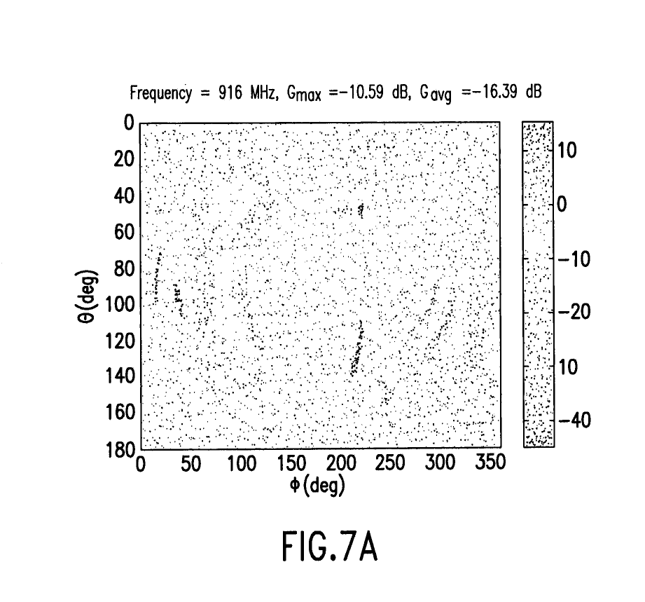

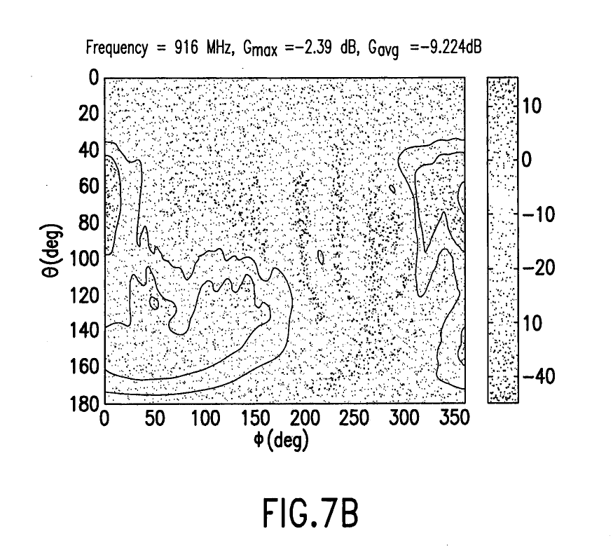

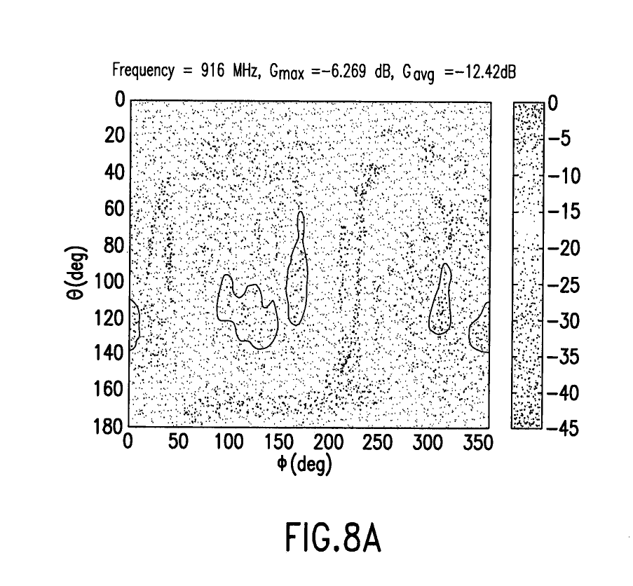

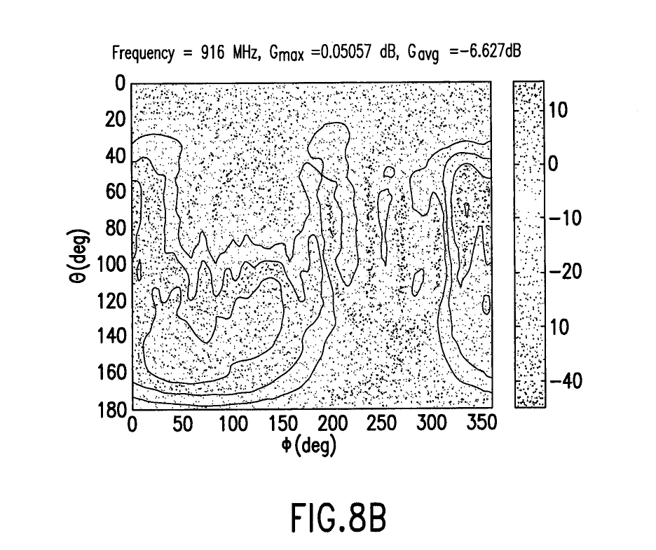

FIGS. 7A and 7B show contour plots of patterns of the narrowband antenna under the load conditions depicted in FIGS. 2A and 2B, respectively. FIGS. 8A and 8B show contour plots of patterns of the LPW antenna under the load conditions depicted in FIGS. 2A and 2B, respectively. The abscissa in the contour plot represents the azimuth angle φ and the ordinate in the contour plot represents the elevation angle θ. The grayed shades and the contour lines represent the magnitude of the gain of the antenna. Points with equal magnitude are represented by a same shade of gray color. The lines delimit the edge between adjacent gain magnitudes. From a contour line to an adjacent contour line, the gain difference is about 10 dB.

The antenna patterns are measured in a SATIMO anechoic chamber, manufactured by Satimo Corporation, at multiple frequency bands (e.g., 900 MHz ISM band in this case) for both the LPW antenna and the narrowband antenna. The narrowband antenna and LPW antenna are embedded in the communication device 21 and both the narrowband antenna and LPW antenna are tested under the two hand grip conditions 26 and 27 as depicted in FIGS. 2A and 2B, respectively. The contour patterns shown in FIGS. 7A, 7B, 8A and 8B also take into account effects of a whole body of a person holding the device 21. In one instance, the person holding the device 21 has a height of about 5 feet and 10 inches and weighs about 178 pounds.

As shown in FIG. 8A, under the loading condition 26 depicted in FIG. 2A, the LPW antenna has a maximum realized gain, at a frequency around 916 MHz, of about −6.3 dB and an average realized gain of about −12.4 dB. Whereas, as shown in FIG. 7A, under the same loading condition as depicted in FIG. 2A, the narrowband antenna has a maximum realized gain, at a frequency around 916 MHz, of about −10.6 dB and an average realized gain of about −16.4 dB. Therefore, the LPW antenna under the hand grip condition 26 depicted in FIG. 2A, provides an improvement of about 4.3 dB in the maximum realized gain and provides an improvement of about 4 dB in the average realized gain.

As shown in FIG. 8B, under the hand loading condition 27 depicted in FIG. 2B, the LPW antenna has a maximum realized gain of about 0 dB and an average gain of about −6.6 dB realized at a frequency around 916 MHz. Whereas, as shown in FIG. 7B, under the same loading condition 27 depicted in FIG. 2B, the narrowband solution has a maximum peak realized gain of about −2.4 dB and an average realized gain of about −9.2 dB, at a frequency around 916 MHz. Therefore, the LPW antenna under the hand grip condition 27 depicted in FIG. 2B, provides an improvement of about 2.4 dB in the maximum realized gain and provides an improvement of about 2.6 dB in the average realized gain.

It can be noted that as the hand grip loading decreases or becomes less severe, the antenna efficiencies for both the narrowband and LPW antennas converge to a free space efficiency of about 30% at 915 MHz. However, when the hand grip loading increases, even though the antenna efficiencies of both the narrowband antenna and the LPW antenna decrease relative to the free space efficiency, the efficiency of the narrowband antenna decreases more drastically compared to the efficiency of the LPW antenna. The efficiency of the narrowband antenna can decrease to a point where the narrowband antenna can become inadequate for transmitting or receiving a signal in the intended frequency band of operation (e.g., ISM frequency band). The average and maximum realized gains obtained at the frequency around 915 MHz are representative for frequencies in the range 902 to 928 MHz.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

Moreover, the method and apparatus of the present invention, like related apparatus and methods used in antenna and telecommunication arts are complex in nature, are often best practiced by empirically determining the appropriate values of the operating parameters, or by conducting computer simulations to arrive at best design for a given application. Accordingly, all suitable modifications, combinations and equivalents should be considered as falling within the spirit and scope of the invention.

In addition, it should be understood that the figures, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. An antenna, comprising:
first and second lateral arms;
a central offset section connected to the first and the second lateral arms; and
a first antenna port connected to the central offset section and a second antenna port connected to the central offset section,
wherein a bandwidth of the antenna is greater than a maximum frequency shift of a resonance frequency of the antenna corresponding to a loading of the antenna by a human hand.

2. The antenna of claim 1, wherein the first and second lateral arms comprise a side segment and a top segment, the top segment and the side segment forming a L-shape.

3. The antenna of claim 2, wherein an angle between the top segment and the side segment is substantially 90°.

4. The antenna of claim 1, wherein the central offset section comprises a conductive material.

5. The antenna of claim 4, wherein the conductive material includes a metal.

6. The antenna of claim 1, wherein a dimension of the first and second lateral arms is equal to approximately 0.2 of the wavelength of the signal transmitted or received by the antenna.

7. The antenna of claim 1, wherein a dimension of the central offset portion is equal to approximately 0.14 of the wavelength of the signal transmitted or received by the antenna.

8. The antenna of claim 1, wherein the antenna is mounted on a substrate material.

9. The antenna of claim 8, wherein the substrate material comprises a printed circuit board.

10. The antenna of claim 8, wherein the substrate material comprises a dielectric material.

11. The antenna of claim 1, wherein the first and second arms are formed from a continuous electrically conductive material that is free from gaps.

12. The antenna of claim 1, wherein the first antenna port and the second antenna port are offset relative to an edge of the first and second lateral arms.

13. The antenna of claim 1, wherein the antenna has a return loss of less than −6 dB under various loading conditions.

14. The antenna of claim 1, wherein an efficiency of the antenna exceeds an efficiency of a conventional antenna by 3 dB or more.

15. The antenna of claim 1, wherein a percentage bandwidth of the antenna is greater than about 55% of a frequency band of communication for the antenna at a return loss of −6 dB.

16. The antenna of claim 15, wherein the frequency band of communication includes the ISM frequency band lying between approximately 902 MHz and approximately 928 MHz.

17. The antenna of claim 1, wherein the bandwidth of the antenna is approximately 750 MHz at a return loss of −6 dB.

18. A wireless communication device comprising a transmitter and the antenna of claim 1 connected to the transmitter.

19. The wireless device of claim 18, wherein a maximum diagonal dimension of the wireless device is smaller than 5 inches.

20. A method of communicating using a wireless device including an antenna, the antenna having first and second arms, a central offset section connecting to the first and the second lateral arms, and first and second antenna ports connected to the central offset section, the method comprising:
receiving a signal using the antenna, the antenna having a bandwidth greater than a maximum frequency shift caused by a loading of the antenna by a human hand.

21. The method of claim 20, further comprising configuring the antenna so that the bandwidth of the antenna is approximately 750 MHz at an antenna return loss of −6 dB.

22. The method of claim 20, further comprising configuring the antenna so that the antenna has a return loss of less than −6 dB under different hand loading conditions.
